(19) United States
(12) Patent Application Publication
(10) Pub. No.: US 2013/0071822 A1
(43) Pub. Date: Mar. 21, 2013

(54) Interactive System for use in Connection with the Identification and/or Management of Psychological Issues

(71) Applicant: BREAKING FREE ONLINE LIMITED, Manchester (GB)

(72) Inventor: Lloyd Humphreys, Greater Manchester (GB)

(73) Assignee: BREAKING FREE ONLINE LIMITED, Manchester (GB)

(21) Appl. No.: 13/647,666

(22) Filed: Oct. 9, 2012

Related U.S. Application Data
(63) Continuation-in-part of application No. PCT/GB2011/050241, filed on Feb. 10, 2011.
Application No. PCT/GB2011/050241 is a continuation of application No. PCT/EP2010/058456, filed on Jun. 16, 2010.

(30) Foreign Application Priority Data
Apr. 8, 2010 (GB) 1005835.2

(51) Int. Cl. G09B 5/00

(52) U.S. Cl. CPC G09B 5/00
USPC 434/236

(57) ABSTRACT

A system for use in the management of psychological issues comprises: a user terminal connected to a remote server 110 via a communication link 105. The user terminal 101 comprises at least a display 102, user actuable input means 103 and an interface engine 104 operable in conjunction with the display 102 and the user input means 103 to provide structured data interfaces facilitating user input of data which may be forwarded over the communication link 105. The remote server 110 comprises a management engine 111 operable to receive and process data from the interface engine 104 via network 105. Based on the inputs to psychological data input interfaces a classification interface 400 is generated and displayed comprising selectable indicator areas 411-416 relating to specific categories of psychological issues, colour coded so that a user can readily identify the areas where the issues are most serious.

This application is a continuation-in-part of International Application No. PCT/GB2011/050241 filed on Feb. 10, 2011, which in turns claims priority from United Kingdom Application No. 1005835.2 filed on Apr. 8, 2010 and International Application No. PCT/EP2010/058456 filed on Jun. 16, 2010, and which are hereby incorporated by reference.

The present invention relates to a system for use in connection with the identification and/or management of psychological issues.

Psychological problems are complex and are susceptible to management using a diverse range of strategies. These strategies may include pharmaceutical treatments, therapy programs, support groups and structured coping strategies. In many circumstances, a patient may ultimately follow an existing treatment program set out in a book, leaflet computer presentation or by a lay support group. In other circumstances the patient may select a program in consultation with a psychologist. In these circumstances, in view of the usual time constraints on contact time, the psychologist will typically guide a patient through one or more existing programs.

Whilst these programs are generally useful in dealing with psychological issues most operate on a very linear, prescriptive basis. This is because they are, by necessity, generic strategies set out in advance. Commonly, patients will drop out of such programs due to dissatisfaction either with the rate of progress or with the issues that are addressed initially.

It is therefore an object of the present invention to provide a system that at least partially overcomes or alleviates such problems.

According to a first aspect of the present invention there is provided an interactive system for use in connection with the identification and/or management of psychological issues comprising:

a user terminal comprising: a display unit; user actuable input means; and an associated interface engine wherein the display unit and user actuable input means are operable under the control of the interface engine to display one or more structured user interfaces and receive user inputs to said structured user interfaces and wherein the plurality of structured user interfaces includes one or more psychological data input interfaces;

a management engine operable to: receive inputs from the user terminal; process user inputs relating to any one of the one or more psychological data input interfaces and thereby formulate a classification of psychological issues based on said received user inputs;

wherein the interface engine is subsequently operable in response to the management engine classification to generate and display a classification interface comprising a plurality of selectable indicator areas, each indicator area relating to a particular category of psychological issues identified in the classification, the appearance of each indicator area varying in accordance with the severity of issues within the corresponding category; and

wherein selection of an indicator area within the classification interface causes the interface engine to retrieve additional information related to the corresponding category of psychological issues and output said additional information to said display unit for display.

The present invention thus provides a system whereby a user can obtain an assessment of their psychological issues directly by way of an automated system but wherein said user can additionally directly obtain further information relating to specific categories of their psychological issues at an order of their own choice. In this manner a user may readily identify their psychological issues and may subsequently embark on a non-linear management strategy in relation to selected psychological issues as they desire.

The variation in appearance of the indicator areas is preferably provided by varying the colour of the indicator areas in accordance with the severity of issues within the corresponding category as determined in the classification. In one preferred implementation, indicator areas corresponding to categories where issues are classified as serious are coloured red; indicator areas corresponding to categories where issues are classified as intermediate are coloured amber; and indicator areas corresponding to categories where issues are classified as minor are coloured green. In other embodiments, the shape of the indicator areas may be varied in response to severity. Additionally or alternatively, the indicator areas corresponding to categories where issues are classified as most severe may be periodically highlighted or flash.

Each indicator area may be provided with an identifying label. The identifying label may comprise text and/or icons identifying the particular category of issues to which the indicator area corresponds.

Each indicator area may comprise one or more sub-areas relating to sub-categories within the particular category of psychological issues. In implementations containing sub-areas, the sub-areas may be hidden unless the indicator area is selected. In such implementations selection of an indicator sub-area causes the interface engine to retrieve and display additional information related to the corresponding sub-category of psychological issues.

The sub-areas may each be provided with an identifying label. The identifying label may comprise text and/or icons identifying the particular sub-category of issues to which the indicator sub-area corresponds.

Information retrieved and displayed in response to area or sub-area selection may comprise any one or more of text, still images, video files, audio files, interactive or non-interactive maps or lists of service providers. Additionally or alternatively, the information may comprise one or more issue specific structured data interfaces. Such issue specific interfaces may be operable to enable the user to plan coping strategies. In particular, such issue specific interfaces may be operable to enable the user to generate real or virtual documents setting out such strategies. The real or virtual documents may comprise maps, schedules, lists, diaries or the like. The real or virtual documents may be interactive documents. The interactive documents may be operable to interact with other systems of the user terminal or other user device. Such systems may include location determination systems, direction determination systems, time keeping systems or any other suitable systems. In response to such interaction, user alerts may be generated or output. The user alerts may comprise, text, audio, still or moving images alone or in combination.

In one implementation, an interactive map may be generated, the interactive map including one or more difficult situation locations. Preferably, an alert may be generated in response to a location determination system. The alerat may be generated whenever the location determination system determines that the terminal, user or another user device is within a threshold distance of and/or approaching a difficult situation location.

The or each structured data interface may be adapted for data input by the provision of one or more selectable input areas. The input areas may be adapted to allow toggle selection of one or more possible input options. The input areas may be adapted to allow quantification in response to one or more possible input options. Additionally or alternatively, the input areas may be adapted to allow entry of alphanumeric data. The or each structured data interface may also comprise one or more control buttons or icons. Additionally or alternatively, the or each structured data interface may contain, information including text, audio data, still or moving graphics relating to the operation of the interface and the selectable input areas.

Structured data interfaces may comprise a single page or multiple successive pages. The user input means may be operable to enable a user to expand, shrink or scroll between different sections of a single page interface or a single page of a multipage interface. Successive pages of a multipage interface may vary in response to user input on an earlier page of the multipage interface.

The management engine may be provided with a data storage unit operable to store data relating to user inputs. The data storage unit may further be operable to store information to be displayed in response to user inputs. The data storage unit may further be operable to store any real or virtual documents generated by a user. The data storage unit may be incorporated into the management engine or may be separate and connected thereto.

The management engine may be provided with a diary engine operable to monitor user activity. The diary engine may prompt the display of particular interfaces or the initiation of communication with a user in response to monitored user activity. The diary engine may be incorporated into the management engine or may be separate and connected thereto.

The management engine may be provided with an identification engine operable to verify the identity of returning users and to assign an identity to new users. The identification engine may be operable in connection with the interface engine to provide a log in and identification input for display on the user terminal The identification engine may be incorporated into the management engine or may be separate and connected thereto.

The system may be incorporated in a single unit. In a preferred embodiment the system comprises multiple user terminals connected to a single separate management engine. In such an embodiment, the management engine may comprise a server or may be connected to a server suitable for directing traffic between the management engine and the user terminals.

The user terminals may comprise dedicated terminals or may comprise any other user device suitable for connection with a remote management engine. In particular, the user terminals may comprise any of: personal computers, laptop computers, notebook computers, tablet computers, smart phones, personal digital assistants or other interactive audio visual devices such as media players or interactive television units. Such user devices may be configured to operate as user terminals by the provision of an application or other adaptation, as required or desired.

The user actuable inputs may be provided in any suitable form. In particular, the user actuable inputs may comprise: touch screens, keypads, pointing devices or the like.

The user terminals may be connected to the management engine by any suitable wired or wireless link including but not limited to fixed line or wireless internet connections or phone networks.

The system may be adapted to relate to psychological issues generally or areas of psychological issues more specifically. For instance, the system may be specially adapted to relate to psychological issues associated with substance abuse, weight gain, mental health or various additions.

According to a second aspect of the present invention there is provided a classification interface providing a classification of a user's psychological issues based on received user inputs, the said classification interface comprising:

a plurality of selectable indicator areas, each indicator area relating to a particular category of psychological issues identified in the classification, the appearance of each indicator area varying in accordance with the severity of issues within the corresponding category; and

wherein selection of an indicator area within the classification interface causes the interface to retrieve and display additional information related to the corresponding category of psychological issues.

The interface of the second aspect of the present invention may incorporate any or all aspects of the system of the first aspect of the present invention, as desired or as appropriate.

According to a third aspect of the present invention there is provided a method of identifying and/or managing psychological issues, the method comprising the steps of:

receiving user inputs from one or more psychological data input interfaces; processing said received user inputs so as to formulate a classification of psychological issues based on said received user inputs;

generating and displaying a classification interface comprising a plurality of selectable indicator areas, each indicator area relating to a particular category of psychological issues identified in the classification, the appearance of each indicator area varying in accordance with the severity of issues within the corresponding category; and

displaying additional information related to the corresponding category of psychological issues in response to selection of an indicator area.

The method of the third aspect of the present invention may incorporate any or all aspects of the system and interface of the first and second aspects of the present invention, as desired or as appropriate.

In order that the invention may be more clearly understood one embodiment will be described further herein, by way of example only, and with reference to the accompanying drawings, in which:

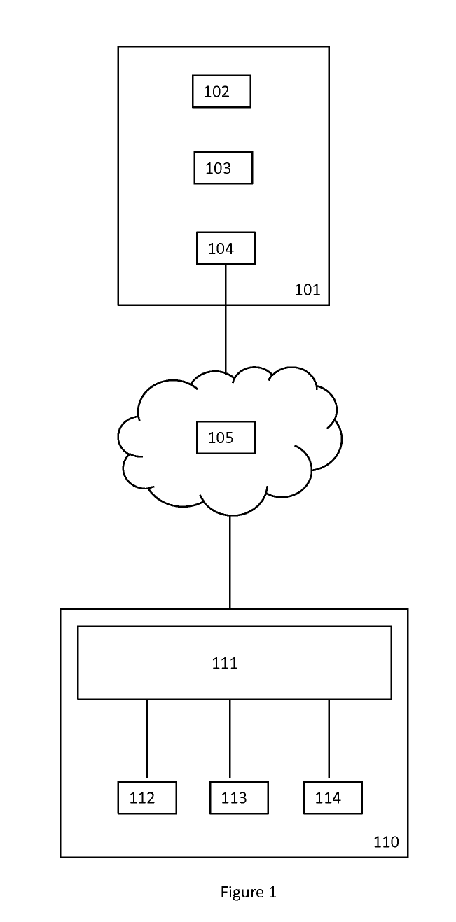

FIG. 1 is a schematic block diagram of a system according to the present invention;

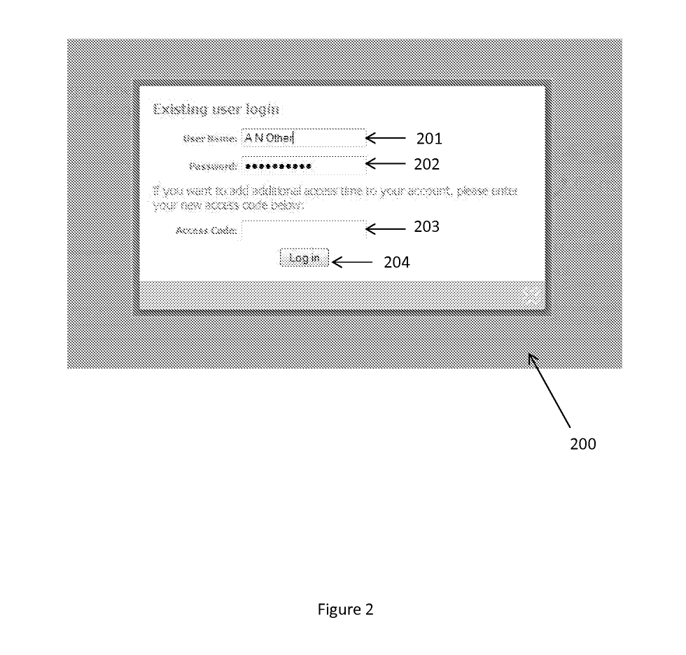

FIG. 2 is an example of a user identification interface in an implementation of the present invention;

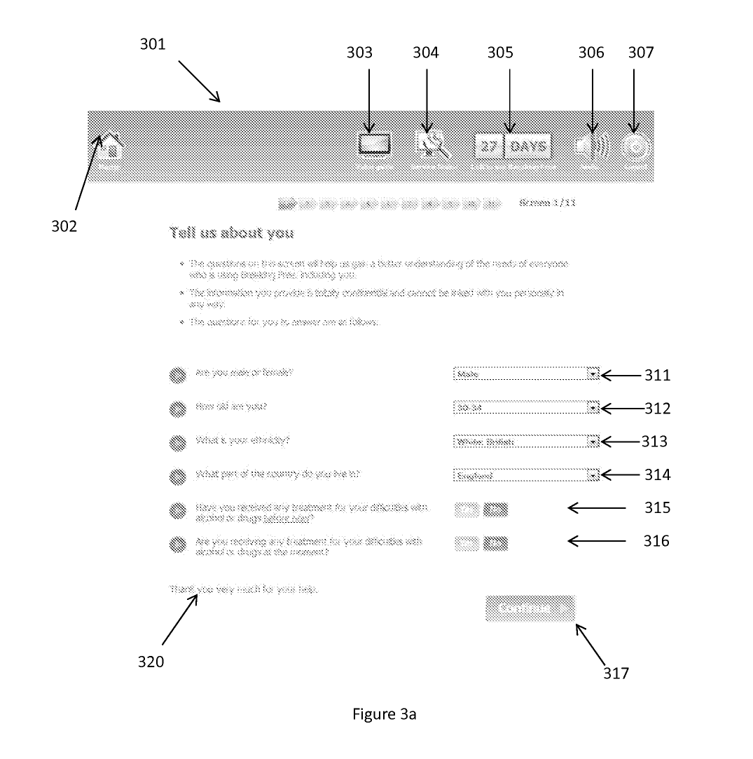

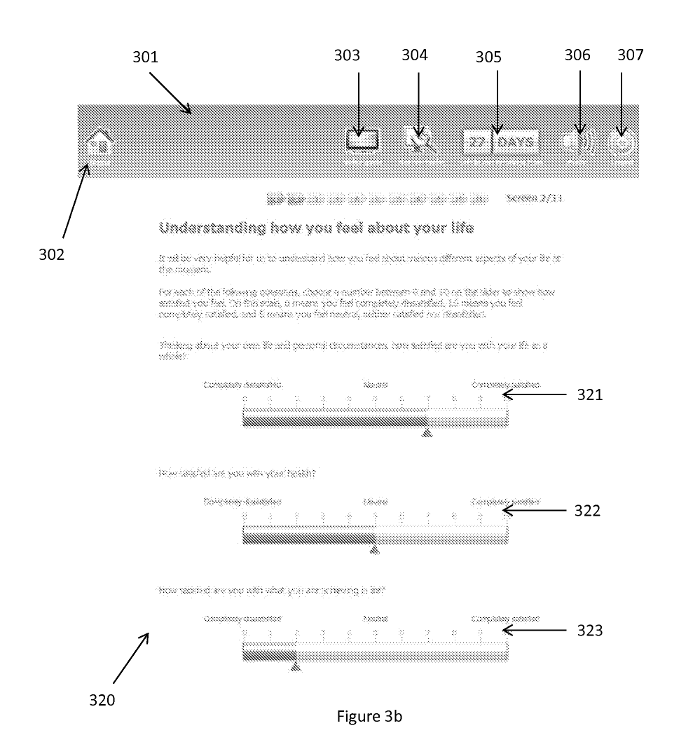

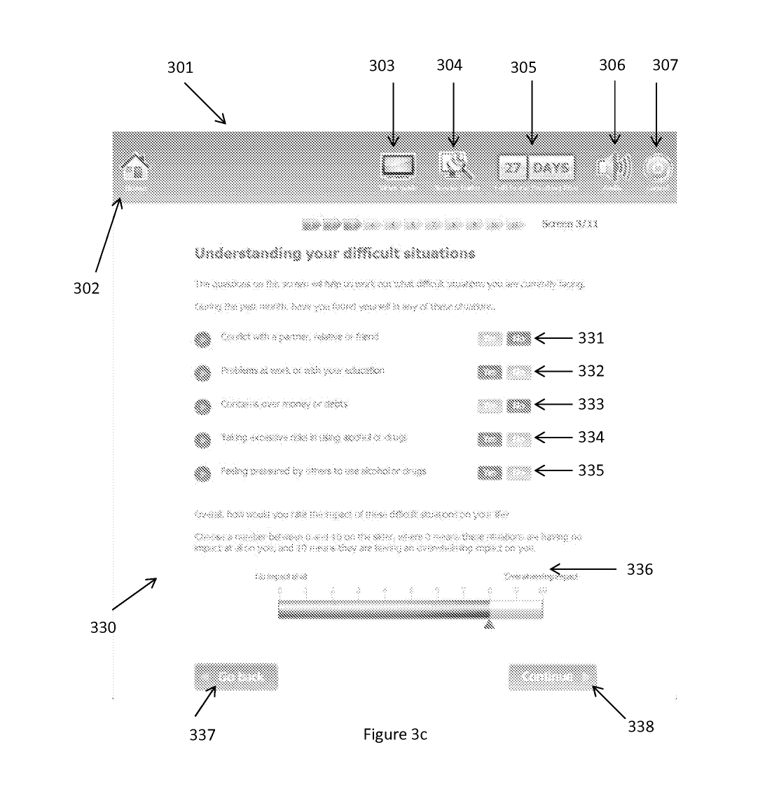

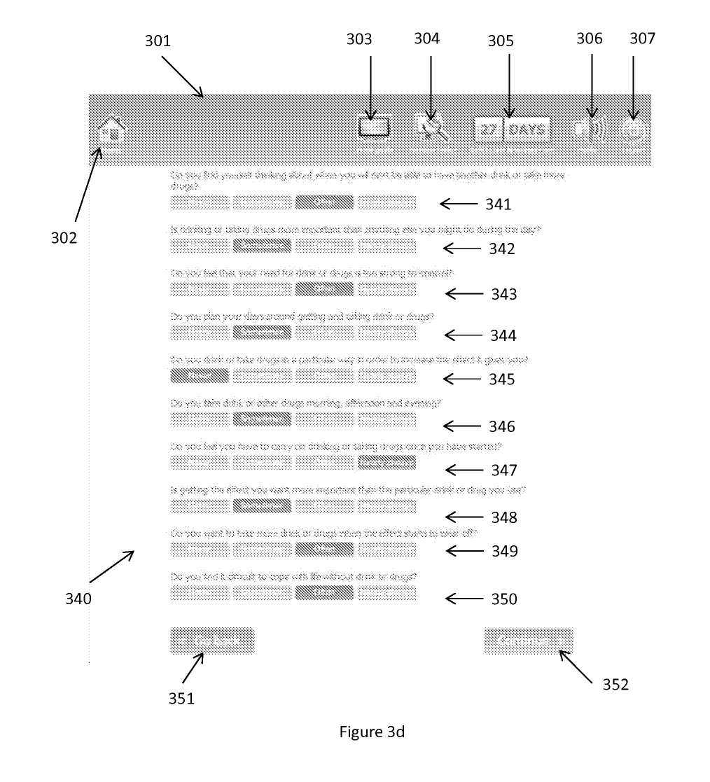

FIGS. 3a-d are examples of psychological data input interfaces in an implementation of the present invention;

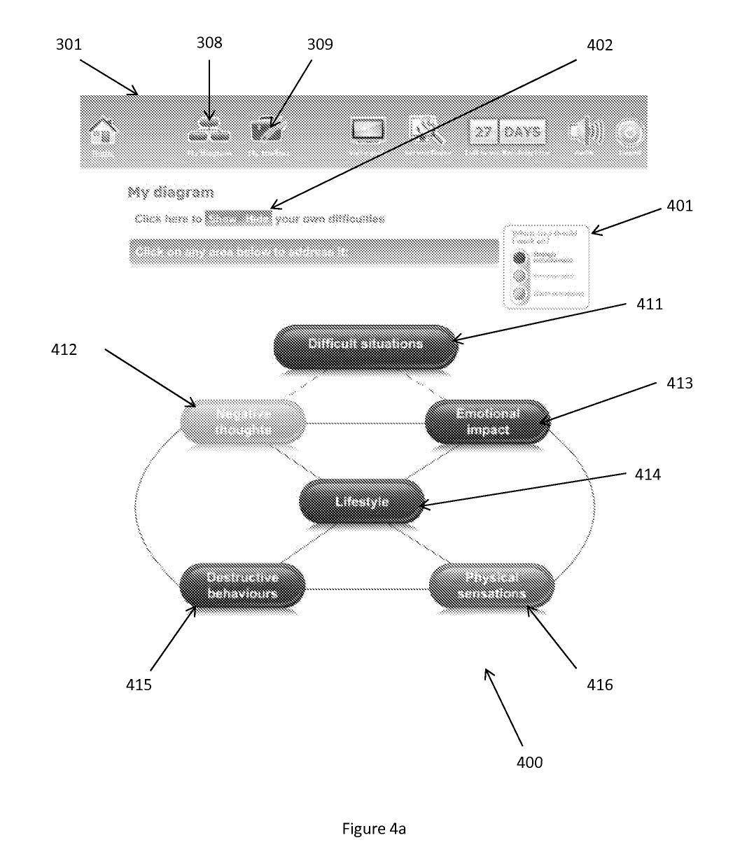

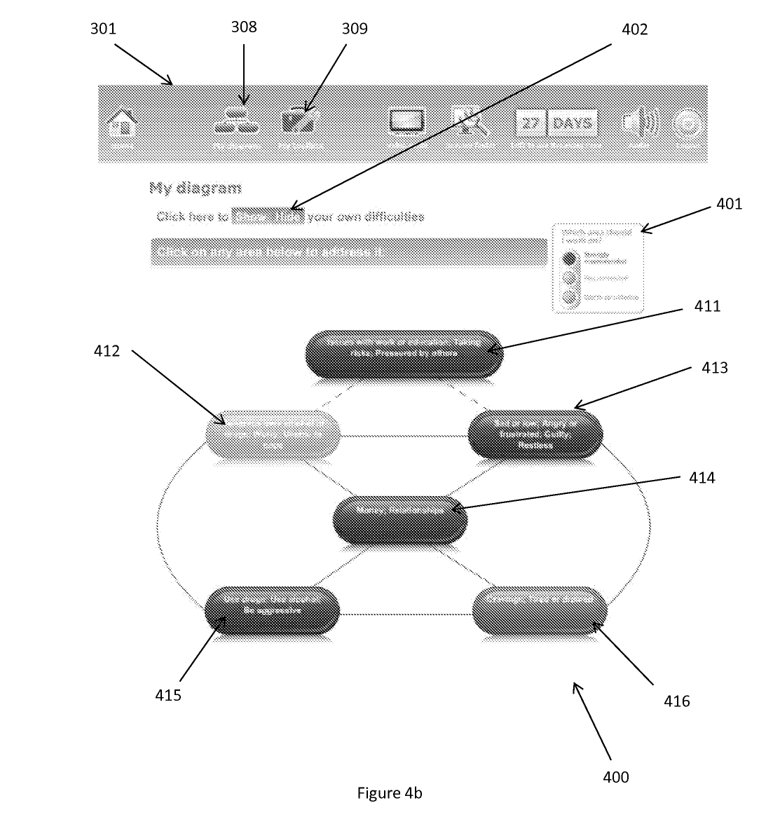

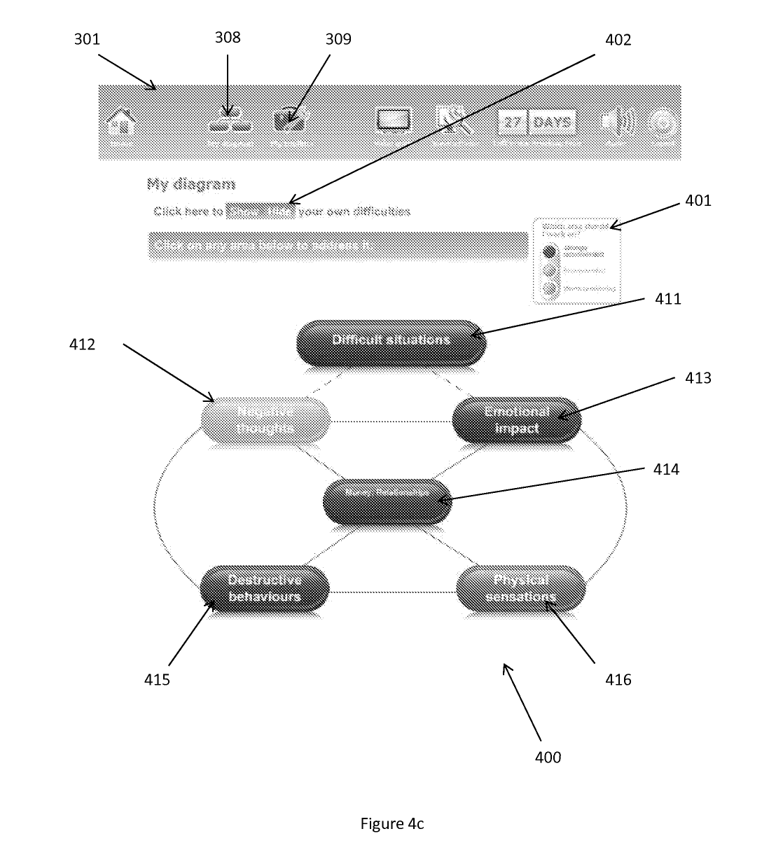

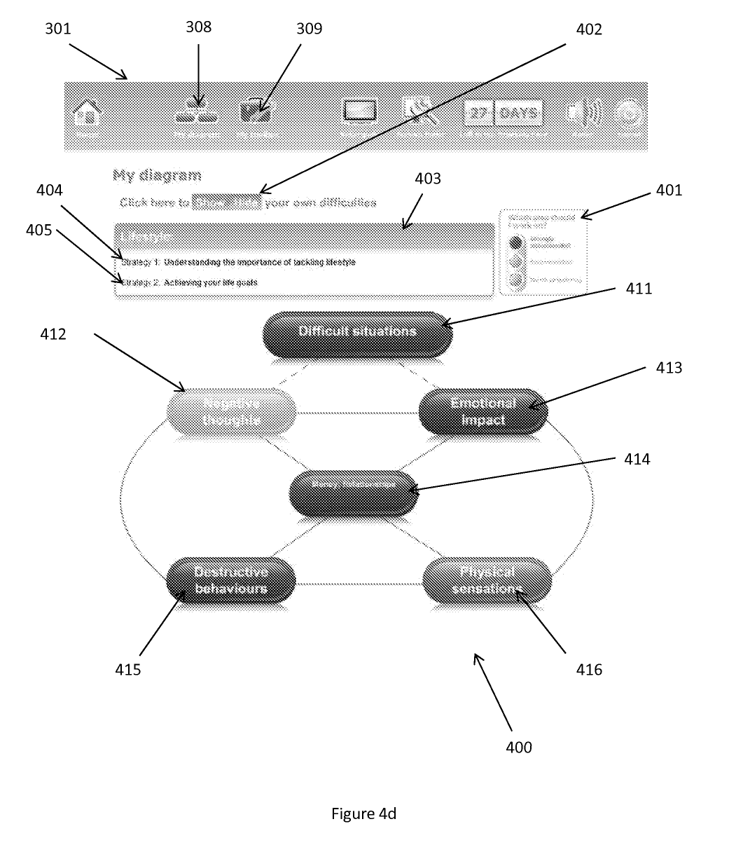

FIGS. 4a-d are examples of a classification interface in an implementation of the present invention;

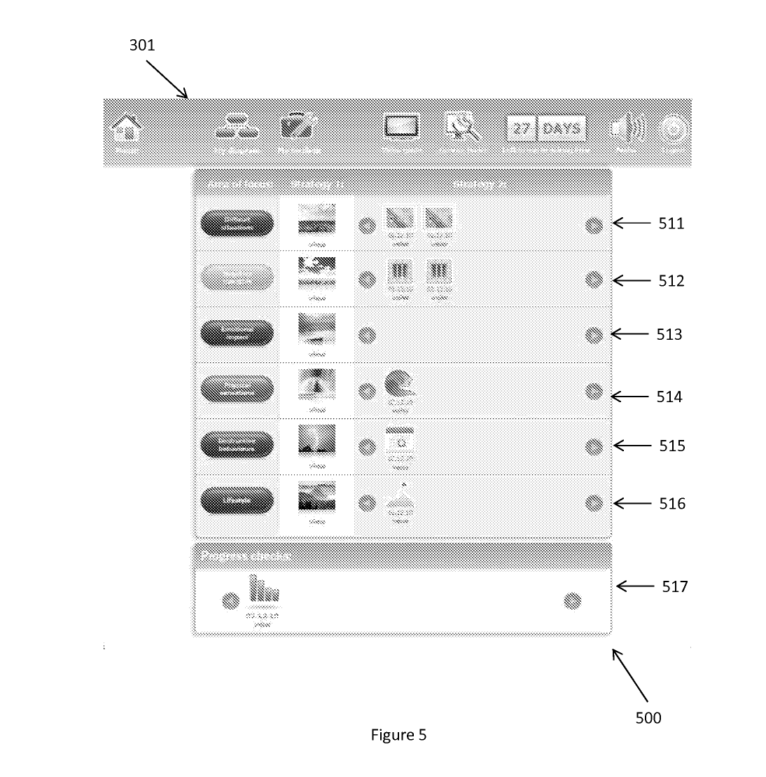

FIG. 5 is an example of a toolbox interface in an implementation of the present invention; and

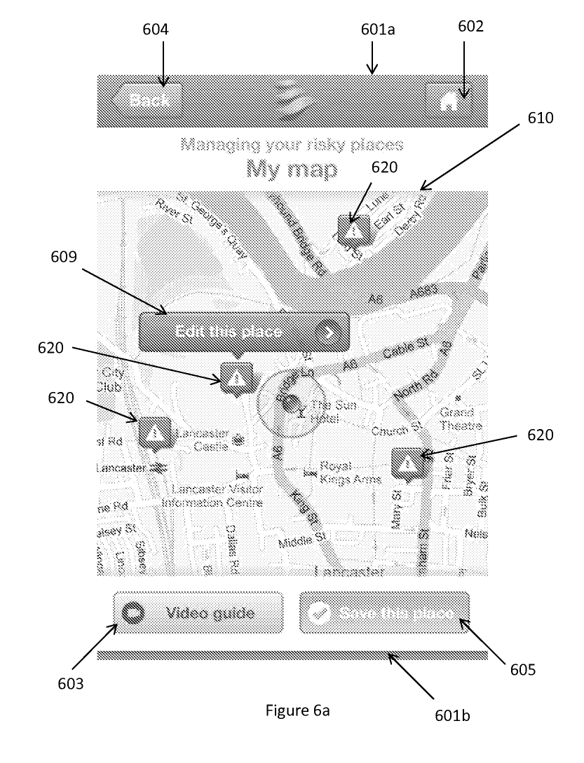

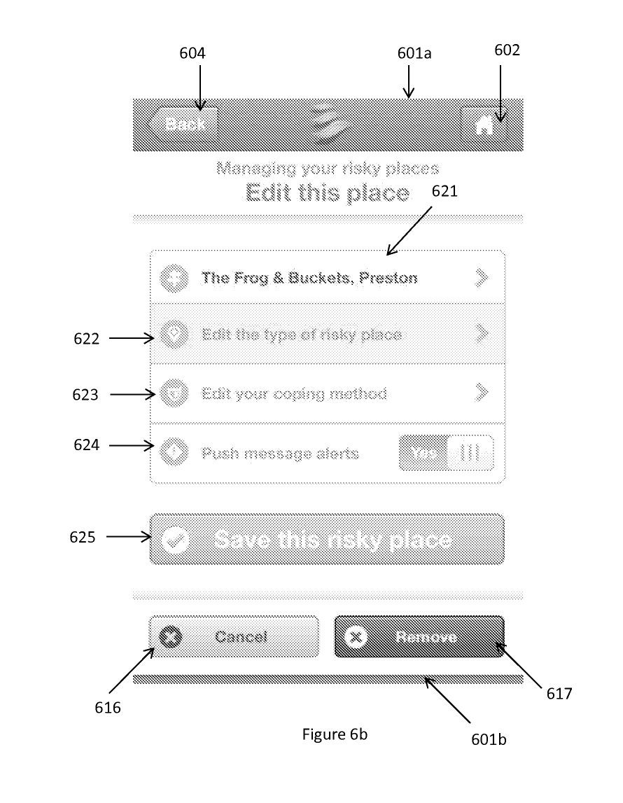

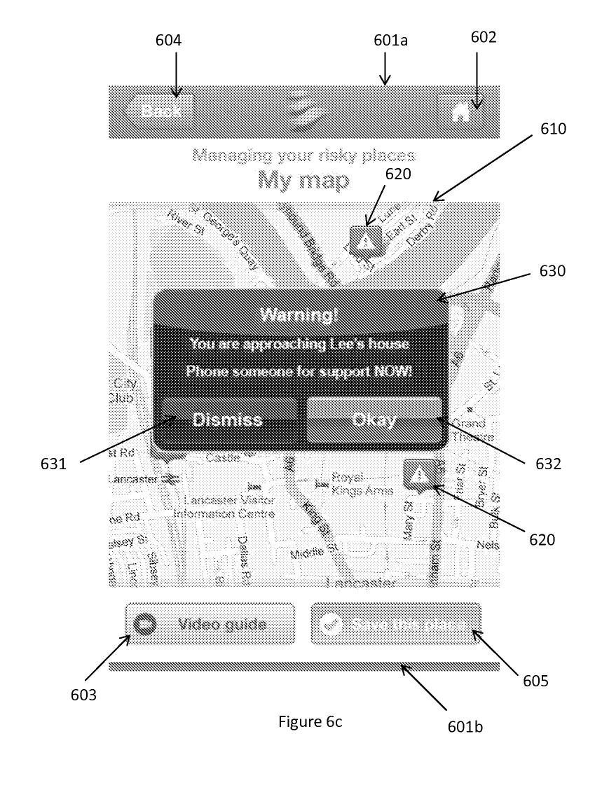

FIG. 6a is an example of an interactive map interface in an implementation of the present invention;

FIG. 6b is an example of sub-interface related to the interactive map interface of FIG. 6a; and

FIG. 6c is an example of an alert generated by the interactive map interface of FIG. 6a.

Turning now to FIG. 1, a system for use in connection with the management of psychological issues comprises: a user terminal 101 connected to a remote server 110 via a suitable communication link 105. The user terminal 101 comprises at a least a display 102, user actuable input means 103 and an interface engine 104. The interface engine 104 is operable in conjunction with the display 102 and the user input means 103 to provide one or more structured data interfaces facilitating user input of data. The interface engine 104 is then operable to forward said input data over the communication link 105. In the present invention, the interface engine 104 is operable to provide one or more structured psychological data input interfaces enabling a user to thereby input data relating to their psychological issues.

The remote server 110 comprises a management engine 111 connected to a data storage unit 112, an identification engine 113 and a diary engine 114. The management engine 111 is operable to receive and process data from the interface engine 104 via network 105. The data storage unit 112 is operable to provide a location for the storage of user input data and any further data required to implement the system. The identification engine 113 is operable to assign an identity to new users and to verify the identity of returning users. This may be achieved by prompting the interface engine to provide a log in and identification interface. The diary engine 1144 is operable in combination with the management engine 111 and the identification engine 113 to monitor user activity and to prompt the display of specified interfaces or initiate communication with a user at specified times.

The skilled man will appreciate that multiple separate user terminals 101 may connect to the server 110 and that the communication link may be of any suitable wired or wireless form.

In use, the user terminal 101 initially displays a log in interface and, if appropriate details are input thereto, the user identity is verified by the identification engine. The management engine 11 may then prompt the interface engine 104 to provide one or more structured psychological data interfaces on the user terminal 101. In due course, the interface engine 104 forwards user input psychological data to the management engine 111. The management engine 111 processes the received data relating to a user's psychological issues and thereby formulates a classification of the user's issues. The management engine 111 may also store the received data and/or the classification in the data storage unit 112.

Ultimately, the management engine 111 forwards the classification to the interface engine 104. This prompts the interface engine to provide a classification interface upon the user terminal 101. The classification interface comprises a plurality of selectable indicator areas, each indicator area corresponding to a particular category of psychological issues identified in the classification. The appearance of each indicator area is dependent upon the severity of the psychological issues identified in the corresponding category. Selection of an indicator area using the input means 103 results in display of further information relating to the corresponding category of psychological issues. This further information may be an additional interactive interface and/or may be information presented audibly or visual in the form of text, numbers, still or moving images. The information may be designed merely to further educate the user in relation to specific aspects of the issues or may be designed to allow the user to develop management strategies in relation to the issues.

For clarity, examples of possible implementations of a number of the above mentioned interfaces will be discussed. Turning first to FIG. 2, a log in and identification interface 200 is shown. The interface comprises selectable free text input areas 201, 202 and 203 allowing the user to enter a user name, password and access code respectively and a log in button 204. The user name and password may be used by the identification engine 113 to verify user identity; the access code may be used by the diary engine to verify whether the user's access subscription has expired.

After a user has successfully logged on, the interface engine 104 may provide successive psychological data input interfaces 310-340 such as those shown in FIGS. 3a-3d. Each interface comprises a common tool bar 301 providing selectable input areas 302-307. As shown in the figures: selection of the home button 302 returns users to a home screen or home interface; selection of the video guide button 303 initiates display of a video guide; selection of the service finder button 304 generates a list and/or interactive map of local providers of psychological help and support; the timer icon 305 indicates the remaining period on a user's subscription; selection of the audio button 306 toggles audio output associated with the interface between on and off; and selection of the logout button 307 logs the user out of the system.

FIG. 3a comprises a series of drop down menu input areas 311-314; a pair of either or selection button input areas 315, 316; a data entry complete selection button 317. FIG. 3b comprises a series of slider bar input areas 321-323 allowing a user to quantify their response to specific questions. FIG. 3b is scrollable to reveal further slider bar input areas and a data entry complete button. FIG. 3c comprises a series of either or selection button input areas 331-335; an associated slider bar input area 336; a revise previous data entry button 337; and a data entry complete selection button 338. FIG. 3d comprises a series of four way either or selection button input areas 341-350; a revise previous data entry button 351; and a data entry complete selection button 352.

Turning now to FIGS. 4a-4d, a classification interface 400 based on the inputs to a plurality of psychological data input interfaces is shown. The interface 400 comprises a plurality of selectable indicator areas 411-416 relating to specific categories of psychological issues. The appearance of the indicator areas 411-416 is also colour coded according to key 401 so that a user can readily identify the areas where the issues are most serious, based on their input data. In the present example: indicators areas 411 & 413-415 (corresponding to the categories difficult situations, emotional impact, lifestyle and destructive behaviours respectively) are colour coded as strongly recommended for further attention; indicator area 412 (corresponding to negative thoughts) is colour coded as recommended for further attention; and indicator area 416 (corresponding to physical sensations) is colour coded as worth considering for further attention.

The classification interface thus provides a readily intelligible overview of a user's psychological issues and their relative severity. The user can thus easily identify their issues and which issues might be in most urgent need of management.

There is also provided a show hide toggle button 402. Selection of button 402 changes the information displayed within the indicator areas 411-416 so as to indicate the particular sub-categories within the main category that are issues. An example of the classification interface 400 following selection of button 402 is shown at FIG. 4b. Here it can be seen, for example, that based on the input data the subcategories of money and relationships are the issues of concern within the broader category of lifestyle. As is shown in FIG. 4c, as an alternative to using button 402, it is possible to directly select one of the indicator areas 411-416. In this example indictor area 414 is selected and thus displays the relevant subcategories of issues.

A further selection of one of the indicator areas 411-416, when displaying subcategories, results in the display of a strategy selection box 403 on interface 400. This is illustrated in FIG. 4d. Here the lifestyle indicator area 414 has been selected and the selection box 403 provides two selectable strategies 404, 405. Selecting the strategies may provide the user with further information relating to the issues and/or may provide the user with one or more further interfaces. On such further interfaces, the user may be able to interactively plan coping strategies or generate real/virtual documents relating to their issues or such strategies. For example, a user may be provided with interfaces allowing them to generate a map of difficult situation locations, a plan of future activities or a step by step guide to achieving a specific goal. Any such documents may be printed by a user and/or stored in the storage unit 102. In alternative implementations, the documents may be interactive, one particular example of an interactive document being described in relation to FIG. 6 below.

In this manner, the user may readily access from the classification interface 400 information relating to their specific psychological issues of interest. As the information may be purely informative or may comprise interactive interfaces the user can select thee issues of most importance to them to tackle in an order of their choosing. The user may also readily set their own pace of progress in dealing with these issues.

As is shown on FIGS. 4a-4d there are additional buttons 308 and 309 on the tool bar 301. Button 308 returns the user to the classification interface 400. Button 309 takes the user to a toolbox interface 500, an example of which is shown in FIG. 5. In the toolbox interface there are a plurality of archive areas 511-516 corresponding to the indicator areas 411-416 of the classification interface. The archive areas contain icons allowing the user to directly access the associated strategy information, interfaces or stored documents. A further archive area 517 allows a user to select icons corresponding to one or more progress reports detailing changes in their issues over the period of use of the system.

The toolbox interface 500 thus provides a user with ready access to any previous exercises and materials. It also allows a user to readily keep a track of their progress in management of these issues.

Turning now to FIG. 6, an implementation of the invention operable to generate and present interactive documents to a user is described. In the example described the interactive document is a map however other forms of interactive document may be generated as required or desired. The map interface 600 shown in FIG. 6 is adapted for implementation by a smartphone as a user terminal but the skilled man will appreciate that the interface may equally be implemented by any other suitable device.

In operation, once selected by way of selecting an indicator area 411-416 and then subsequently selecting an interactive map indicator (not shown), a map interface 600 is generated. The map interface 600 comprises a map display 610 and tool bars 601a, 601b comprising selectable indicator areas 602-605. As shown in FIG. 6: selection of the home button 602 returns users to a home screen or home interface; selection of the video guide button 603 initiates display of a video guide; selection of the back button 604 returns users to a prior interface; and selection of the save button 605 saves the a difficult situation location on the map.

The map display 610 may be a simple image or may comprise data generated by or retrieved from a separate mapping application. The map display may be navigated by scrolling and/or zooming in/out as required or desired. An appropriate map display as to location can be generated by user selection or automatically by considering the user identity. Additionally or alternatively, if the user terminal 101 is provided with location determining means (e.g. a GPS (Global Positioning System) unit or similar) this can be used to automatically select a suitable location map display 610.

Within the map display 610, a user may select one or more difficult situation locations 620. Selecting such locations generates a difficult situation selectable icon 609 associated with the location on the map. By selecting icon 609, the user can then access a further interface (FIG. 6b) by means of which information about the location, the difficulties and coping strategies may be input. In particular, the user may be presented with one or more selectable areas 621-615. The example shown: selection of the location name button 621 allows users to input or edit the name of the location; selection of the location type button 622 allows users to input or edit information as to the location type; selection of the coping strategy button 623 allows users to input or edit coping strategies associated with the location; selection of the push alert button 624 allows users to input or select alert message options associated with the location; and selection of the save button 625 allows users to save any input or edited information. Whilst within this interface, the tool bar 601b may include alternative selectable areas 616-617: selection of the cancel button 616 returns users to the map display 610 without saving; and selection of the remove button 617 returns users to the map display 610 and deletes the location. When a user exits the interface 600, the information entered or edited can be stored. In the event that the user terminal 101 is in communication with remote server 110, this information can be synchronised with the server 110.

Following generation, the interactive map may be stored or may be actively monitored by the user terminal 101. In particular, if the user terminal 101 is a portable device including a location determining means (for example, a smartphone with a GPS unit), the user terminal 101 can monitor the terminal 101 location (as a proxy for user location) to determine when the user is approaching a difficult situation location. This determination may be made by determining the terminal location to be within a threshold difference of the difficult situation location and/or approaching the difficult situation location. In response to such a determination, an alert may be generated and output. The nature of the alert may be determined by the coping strategy selected by the user. In FIG. 6c, an example alert is shown. In this example, the alert is output as a text warning 630 containing selectable areas 361-632: button 631 allows the user to dismiss the alert; button 632 allows the user to acknowledge the alert and may further be operable to implement an action indicated by the alert. In alternative implantation, the alert may comprise audio and/or visual data. In the example shown the text reads “you are approaching Lee's house, phone someone for support now!”. In some smartphone implementations, selecting button 632 might initiate dialling of a specified support phone number.

The generation of a first alert may in some implementations result in the generation of a subsequent follow up alert after a predetermined time interval, say, 30 minutes. The follow up alert may invite the user to indicate how they coped with the difficult situation location. This indication may be provided via a suitable interface (not shown). Contingent upon the user indication, a congratulation message and/or a exhortation message may be output.

It is of course to be understood that the invention is not to be restricted to the details of the above embodiment which is described by way of example only.

1. An interactive system for use in connection with the identification and/or management of psychological issues comprising:
a user terminal comprising: a display unit; user actuable input means; and an associated interface engine wherein the display unit and user actuable input means are operable under the control of the interface engine to display one or more structured user interfaces and receive user inputs to said structured user interfaces and wherein the plurality of structured user interfaces includes one or more psychological data input interfaces;
a management engine operable to: receive inputs from the user terminal;
process user inputs relating to any one of the one or more psychological data input interfaces and thereby formulate a classification of psychological issues based on said received user inputs;
wherein the interface engine is subsequently operable in response to the management engine classification to generate and display a classification interface comprising a plurality of selectable indicator areas, each indicator area relating to a particular category of psychological issues identified in the classification, the appearance of each indicator area varying in accordance with the severity of issues within the corresponding category; and
wherein selection of an indicator area within the classification interface causes the interface engine to retrieve additional information related to the corresponding category of psychological issues and output said additional information to said display unit for display.

2. An interactive system as claimed in claim 1 wherein each indicator area comprises one or more sub-areas relating to sub-categories within the particular category of psychological issues.

3. An interactive system as claimed in claim 2 wherein the sub-areas are hidden unless the indicator area is selected.

4. An interactive system as claimed in claim 2 wherein selection of an indicator sub-area causes the interface engine to retrieve and display additional information related to the corresponding sub-category of psychological issues.

5. An interactive system as claimed in claim 4 wherein the information comprises one or more issue specific structured data interfaces operable to enable the user to plan coping strategies.

6. An interactive system as claimed in claim 5 wherein such structured data interfaces are operable to enable the user to generate real or virtual documents setting out such strategies.

7. An interactive system as claimed in claim 6 wherein the real or virtual documents comprise any or all of: text, still images, video files, audio files, interactive or non-interactive maps, schedules, lists or diaries.

8. An interactive system as claimed in claim 6 wherein the documents are interactive documents operable to interact with other systems of the user terminal or other user device.

9. An interactive system as claimed in claim 8 wherein the interactive document is an interactive map including one or more difficult situation locations and an alert is generated in response to a location determination system.

10. An interactive system as claimed in claim 6 wherein the or each structured data interface is adapted for data input by the provision of one or more selectable input areas, the selectable input areas adapted to: allow toggle selection of one or more possible input options; allow quantification in response to one or more possible input options; or to allow entry of alphanumeric data.

11. An interactive system as claimed in claim 1 wherein the management engine is provided with a data storage unit operable to store data relating to user inputs and information to be displayed in response to user inputs.

12. An interactive system as claimed in claim 11 wherein the data storage unit is operable to store any real or virtual documents generated by a user.

13. An interactive system as claimed in claim 1 wherein the management engine is provided with a diary engine operable to monitor user activity.

14. An interactive system as claimed in claim 13 wherein the diary engine prompts the display of particular interfaces or the initiation of communication with a user in response to monitored user activity.

15. An interactive system as claimed in claim 1 wherein the management engine is provided with an identification engine operable to verify the identity of returning users and to assign an identity to new users.

16. An interactive system as claimed in claim 1 wherein the system comprises multiple user terminals connected to a single separate management engine.

17. An interactive system as claimed in claim 1 wherein the management engine may comprise a server or is connected to a server suitable for directing traffic between the management engine and the user terminals.

18. An interactive system as claimed in claim 17 wherein the user terminals comprise dedicated terminals or comprise any of: personal computers, laptop computers, notebook computers, tablet computers, smart phones, personal digital assistants, media players or interactive television units configured to operate as user terminals by the provision of an application or other adaptation.

19. A classification interface providing a classification of a user's psychological issues based on received user inputs, the said classification interface comprising:
a plurality of selectable indicator areas, each indicator area relating to a particular category of psychological issues identified in the classification, the appearance of each indicator area varying in accordance with the severity of issues within the corresponding category; and
wherein selection of an indicator area within the classification interface causes the interface to retrieve and display additional information related to the corresponding category of psychological issues.

20. A classification interface as claimed in claim 19 wherein each indicator area comprises one or more sub-areas relating to sub-categories within the particular category of psychological issues.

21. A classification interface as claimed in claim 20 wherein the sub-areas are hidden unless the indicator area is selected.

22. A classification interface as claimed in claim 20 wherein selection of an indicator sub-area causes the interface engine to retrieve and display additional information related to the corresponding sub-category of psychological issues.

23. A classification interface as claimed in any one of claim 22 wherein the information comprises one or more issue specific structured data interfaces operable to enable the user to plan coping strategies.

24. A classification interface as claimed in claim 23 wherein such issue specific interfaces are operable to enable the user to generate real or virtual documents setting out such strategies.

25. A classification interface as claimed in claim 24 wherein the real or virtual documents comprise any or all of: text, still images, video files, audio files, interactive or non-interactive maps, schedules, lists or diaries.

26. An interactive system as claimed in claim 24 wherein the documents are interactive documents operable to interact with other systems of a user terminal or other user device.

27. A classification interface as claimed in claim 24 wherein the or each structured data interface is adapted for data input by the provision of one or more selectable input areas, the selectable input areas adapted to: allow toggle selection of one or more possible input options; allow quantification in response to one or more possible input options; or to allow entry of alphanumeric data.

28. A method of identifying and/or managing psychological issues, the method comprising the steps of:
receiving user inputs from one or more psychological data input interfaces;
processing said received user inputs so as to formulate a classification of psychological issues based on said received user inputs;
generating and displaying a classification interface comprising a plurality of selectable indicator areas, each indicator area relating to a particular category of psychological issues identified in the classification, the appearance of each indicator area varying in accordance with the severity of issues within the corresponding category; and
displaying additional information related to the corresponding category of psychological issues in response to selection of an indicator area.

29. A method as claimed in claim 28 wherein each indicator area comprises one or more sub-areas relating to sub-categories within the particular category of psychological issues.

30. A method as claimed in claim 29 wherein the sub-areas are hidden unless the indicator area is selected.

31. A method as claimed in claim 29 wherein selection of an indicator sub-area causes the display of additional information related to the corresponding sub-category of psychological issues.

32. A method as claimed in claim 31 wherein the information comprises one or more issue specific structured data interfaces operable to enable the user to plan coping strategies.

33. A method as claimed in claim 32 wherein such structured data interfaces are operable to enable the user to generate real or virtual documents setting out such strategies.

34. A method as claimed in claim 33 wherein the real or virtual documents comprise any or all of: text, still images, video files, audio files, interactive or non-interactive maps, schedules, lists or diaries.

35. A method as claimed in claim 33 wherein the documents are interactive documents operable to interact with other systems of a user terminal or other user device.

36. A method as claimed in claim 33 wherein the interactive document is an interactive map including one or more difficult situation locations and an alert is generated in response to a location determination system.

37. A method as claimed in claim 31 wherein the or each structured data interface is adapted for data input by the provision of one or more selectable input areas, the selectable input areas adapted to: allow toggle selection of one or more possible input options; allow quantification in response to one or more possible input options; or to allow entry of alphanumeric data.
